(19) United States
(12) Patent Application Publication
(10) Pub. No.: US 2015/0095503 A1
(43) Pub. Date: Apr. 2, 2015

(54) METHOD AND APPARATUS FOR ACCESSING TO WEB SERVER IN A MOBILE COMMUNICATION SYSTEM

(71) Applicant: Samsung Electronics Co., Ltd., Gyeonggi-do (KR)

(72) Inventors: Han Na Lim, Seoul (KR); Ji Cheol Lee, Gyeonggi-do (KR); Hyung Ho Lee, Seoul (KR)

(21) Appl. No.: 14/503,126

(22) Filed: Sep. 30, 2014

(30) Foreign Application Priority Data
Sep. 30, 2013 (KR) 10-2013-0116179

(51) Int. Cl. H04L 29/08

(52) U.S. Cl. CPC H04L 67/02; H04L 67/141
USPC 709/227

(57) ABSTRACT

According to an embodiment, a web server connecting method of a terminal includes receiving an HTTP (HyperText Transfer Protocol) request for at least one domain, determining whether the domain supports an HTTP proxy service, and if the domain supports the HTTP proxy service, transmitting the HTTP request to an HTTP proxy through a pre-established HTTP proxy connection. In another embodiment, the terminal using the method is provided. In other embodiments, the HTTP proxy for offering the HTTP proxy service to the terminal and a web server connecting method of the HTTP proxy are provided.

### TECHNICAL FIELD

The present invention relates to a method and apparatus for access to a web server in a mobile communication system. More particularly, the present invention provides a method and apparatus for enhancing user's QoE (Quality of Experience) in access to a web server.

### BACKGROUND

Nowadays most of traffic that passes an operator's network in the mobile communication system is http traffic. However, the mobile communication network fails to provide a differentiated processing based on http request characteristics, and merely processes HTTP (HyperText Transfer Protocol) traffic as part of data traffic. Unfortunately, this often causes an undesired increase in a web loading time of a terminal. Normally the web loading time may be divided into a connection time and a response time.

The connection time is defined as the time required for establishing a connection between a terminal and a web server for offering a service of a specific domain. The connection time is formed of a plurality of DNS (Domain Name System) queries and a plurality of TCP (Transmission Control Protocol) connection setups, which are performed by the terminal for receiving a service from a single server.

The terminal performs a DNS query to obtain a web server address and makes an HTTP connection to the web server having the obtained address. In most cases, the HTTP connection is formed of a TCP connection. Hereinafter, the HTTP connection using TCP will be referred to as an HTTP/TCP connection. The terminal sends an HTTP request to the web server. Then the web server sends an index file to the terminal in response to the received HTTP request. The index file contains information about a server to which the terminal for using a service offered from the web server should be connected. The terminal receiving the index file performs a plurality of DNS queries and establishes a plurality of HTTP/TCP connections according to the file.

The response time is defined as the time required for receiving a response from the web server at the terminal. Normally the response time depends on a distance between the terminal and the web server, the amount of server traffics, or the like. When the terminal disconnects from the web server, the HTTP/TCP connection is also ended. If the terminal desires to access again the same domain, the terminal should repeatedly perform the above procedure.

However, in case of a frequent access domain, the repeatedly performed procedure not only becomes a burden to both the terminal and the network, but also causes the terminal to experience a longer web loading time. Additionally, the current mobile communication network merely processes the HTTP request as part of data traffic and fails to perform a differentiated process according to types of HTTP request. Therefore, for user convenience, technique to reduce the web loading time of the terminal is required.

### SUMMARY

Accordingly, the present invention is to provide a method and apparatus for allowing an efficient web server access in the mobile communication system. Particularly, embodiments of the present invention provide a method and apparatus for improving user's QoE by differentiating HTTP traffic.

Additionally, embodiments of the present invention provide a method and apparatus for reducing a web server connection time of a terminal. Further, embodiments of the present invention provide a method and apparatus for allocating QoS to a terminal according to priority of HTTP request.

According to embodiments of the present invention, provided is a method and apparatus for improving a web server access time.

According to an embodiment of the present invention, provided is a method for connecting with a web server at a terminal, comprising receiving an HTTP (HyperText Transfer Protocol) request for at least one domain; determining whether the domain supports an HTTP proxy service; and if the domain supports the HTTP proxy service, transmitting the HTTP request to an HTTP proxy through a pre-established HTTP proxy connection.

According to an embodiment of the present invention, provided is a terminal comprising a communication unit configured to perform a data communication; and a connection controller configured to receive an HTTP (HyperText Transfer Protocol) request for at least one domain, to determine whether the domain supports an HTTP proxy service, and if the domain supports the HTTP proxy service, to transmit the HTTP request to an HTTP proxy through a pre-established HTTP proxy connection.

According to an embodiment of the present invention, provided is a method for connecting with a web server at an HTTP (HyperText Transfer Protocol) proxy, comprising establishing a persistent HTTP connection with a cloud operator which services at least one domain; receiving an HTTP request for the domain from a terminal through an HTTP proxy connection established between the terminal and the HTTP proxy; and transmitting the received HTTP request to the cloud operator through the HTTP connection.

According to an embodiment of the present invention, provided is an HTTP (HyperText Transfer Protocol) proxy comprising a communication unit configured to perform a data communication; and a domain connection controller configured to establish a persistent HTTP connection with a server which services at least one domain, to receive an HTTP request for the at least one domain from a terminal through an HTTP proxy connection established between the terminal and the HTTP proxy, and to transmit the received HTTP request to the server through the HTTP connection.

### BRIEF DESCRIPTION OF THE DRAWINGS

FIG. 1 shows the concept of a network containing HTTP proxy in accordance with an embodiment of the present invention.

FIG. 2 shows a signal flow among respective entities to obtain HTTP proxy related information in accordance with an embodiment of the present invention.

FIG. 3 shows an HTTP proxy management object stored in a terminal in accordance with an embodiment of the present invention.

FIG. 4 is a flow diagram illustrating the operation of a terminal in response to an HTTP request in accordance with an embodiment of the present invention.

FIGS. 5A and 5B show HTTP proxy domain access procedures of a terminal in accordance with embodiments of the present invention.

FIG. 6 shows a network operation in case an HTTP request contains a priority indicator.

FIG. 7 is a block diagram illustrating a terminal in accordance with an embodiment of the present invention.

FIG. 8 is a block diagram illustrating an HTTP proxy in accordance with an embodiment of the present invention.

### DETAILED DESCRIPTION

The following description with reference to the accompanying drawings is provided to assist in a comprehensive understanding of various embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present invention. Accordingly, it should be apparent to those skilled in the art that the following description of various embodiments of the present invention is provided for illustration purpose only and not for the purpose of limiting the present invention as defined by the appended claims and their equivalents.

It is to be understood that the singular forms “a”, “an”, and “the” include plural referents unless the context clearly dictates otherwise. Thus, for example, reference to “a signal” includes reference to one or more of such signals.

In order to solve or obviate the above-discussed issues or disadvantages, at least one embodiment of the present invention provides a method and apparatus for reducing a connection time of a terminal. Particularly, an embodiment of the present invention proposes an HTTP proxy as a solution for reducing the connection time of the terminal.

According to an embodiment of this invention, in case a user makes an access request to a specific domain, a terminal (also referred to as user equipment (UE)) may transfer an HTTP (HyperText Transfer Protocol) request to an HTTP proxy through a pre-established HTTP proxy connection. Then the HTTP proxy transfers the received HTTP request to a web server, which offers a service of the specific domain, through the pre-established HTTP connection with the specific domain. This procedure may prevent the occurrence of connection delay factors.

Additionally, this invention proposes the HTTP proxy so as to allocate proper QoS (Quality of Service) to the terminal according to the priority of the HTTP request. The HTTP proxy transfers information about the priority of the HTTP request to an entity taking charge of QoS in an operator's network such that the terminal can obtain proper QoS.

An embodiment of this invention proposes the HTTP proxy in order to reduce the connection time of the terminal. The HTTP proxy may have a guaranteed HTTP connection previously connected with the specific domain on the operator's network.

According to an embodiment of this invention, when the user makes the access request to the specific domain, the terminal transfers the HTTP request to the HTTP proxy rather than to the web server which offers a service of the specific domain. At this time, the terminal may entrust a DNS (Domain Name System) query about the specific domain to the HTTP proxy.

In an embodiment of this invention, an HTTP connection between the terminal and the HTTP proxy is referred to as an HTTP proxy connection, which may be established when the terminal initially accesses the network or established at the request of the terminal. The HTTP proxy connection is maintained in the terminal till a specific time point. The HTTP proxy transfers the received HTTP request to the web server which offers a service of the specific domain. The specific domain connected with the HTTP proxy may be determined on the basis of a contract between a network operator and a specific domain operator.

In order to realize the above procedure, the terminal may receive, from the network, or store therein information for determining whether to send the HTTP request to the HTTP proxy or establish directly the HTTP connection with the web server. Based on this information, the terminal determines a target for transmission of the HTTP request.

In an embodiment of this invention, a mobile communication network operator may have a contract for a quick HTTP access with one or more cloud operators which offer a service of the specific domain. The HTTP proxy may establish a guaranteed HTTP connection with a domain/server serviced by the cloud operator. The guaranteed HTTP connection may be realized as a persistent TCP connection and utilize SDN technique.

In case the user makes the access request to the specific domain, the terminal transfers the HTTP request to the HTTP proxy through the HTTP proxy connection. Then the HTTP proxy may transfer the received HTTP request to the web server for the service of the specific domain through a preestablished guaranteed HTTP connection. If the HTTP proxy establishes a connection with two or more cloud operators for offering a service of the specific domain, the HTTP proxy selects one of the cloud operators according to network conditions or the like. Through this procedure, the time for HTTP/TCP connection setup is reduced, and the time caused by a DNS query is also reduced.

Now, embodiments of this invention will be described in more detail with reference to drawings.

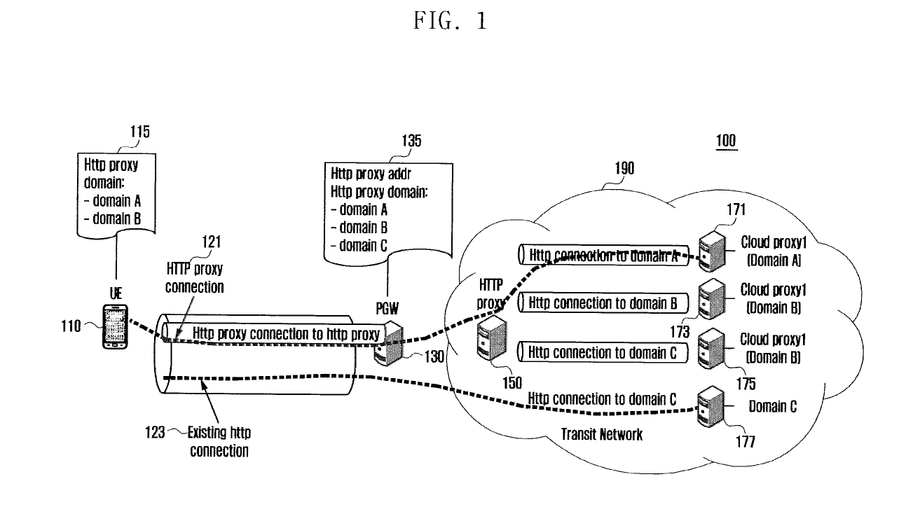

First, an HTTP proxy connection in a network containing HTTP proxy will be discussed with reference to FIG. 1. FIG. 1 shows the concept of a network containing HTTP proxy in accordance with an embodiment of the present invention.

Referring to FIG. 1, the network 100 may include a terminal (hereinafter, referred to as user equipment (UE)) 110, a P-gateway (PGW) 130, an HTTP proxy 150, and cloud proxies 171, 173, 175 and 177. In an embodiment shown in FIG. 1, the HTTP proxy 150 is located at the rear of the PGW 130 and establishes guaranteed HTTP connections with a cloud proxy 1 which services domains A and B, and with a cloud proxy 2 which services a domain B. In other words, a mobile communication operator makes a contract with cloud operators 1 and 2.

Depending on embodiments, the UE 110 may store therein information about a specific domain to transmit an HTTP request to the HTTP proxy 150. This specific domain will be referred to as an HTTP proxy domain in this disclosure. A procedure of obtaining the HTTP proxy domain will be described later.

According to this embodiment shown in FIG. 1, the UE 110 may store, as the HTTP proxy domain, a domain A and a domain B. Additionally, the PGW 130 may store therein information related to the HTTP proxy 150. The HTTP proxy related information may include an address of the HTTP proxy 150, information about a domain connected with the HTTP proxy 150, and the like. The UE 110 may receive the HTTP proxy related information from the PGW 130. Also, the UE 110 may receive the HTTP proxy related information corresponding to subscriber information thereof.

The HTTP proxy related information may be stored in the PGW 130 by means of operator's configuration. According to this embodiment shown in FIG. 1, the PGW 130 stores therein an address of the HTTP proxy 150 and information about domains A, B and C which are serviced by the HTTP proxy 150.

Depending on embodiments of this invention, in case a user requests an access to the domain A, the UE 110 identifies an HTTP proxy domain and transfers an HTTP request to the HTTP proxy 150 through an HTTP proxy connection 121. A procedure of establishing the HTTP proxy connection 121 will be described later. The HTTP proxy 150 may transfer the HTTP request to the cloud proxy 171 which offers a service of the domain A.

In case a user requests an access to a domain C, the UE 110 establishes, through an existing HTTP connection 123, a direct connection with a web server 177 which offers a service of the domain C.

The above-discussed quick HTTP connection realized by the HTTP proxy 150 may be provided as a differentiated service to a user by a mobile communication operator. This differentiated service may be referred to as an HTTP proxy service. In this case, a network operator may identify user's subscription information when offering the HTTP proxy service. Alternatively, a mobile communication operator may offer the HTTP proxy service to specific UE only or determine whether to offer the HTTP proxy service according to network conditions.

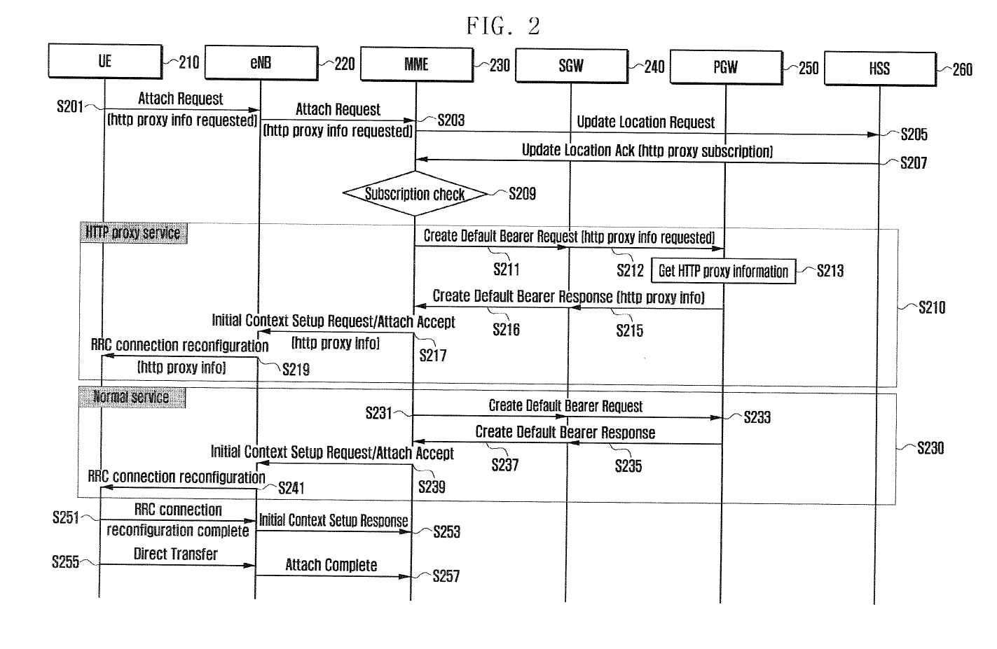

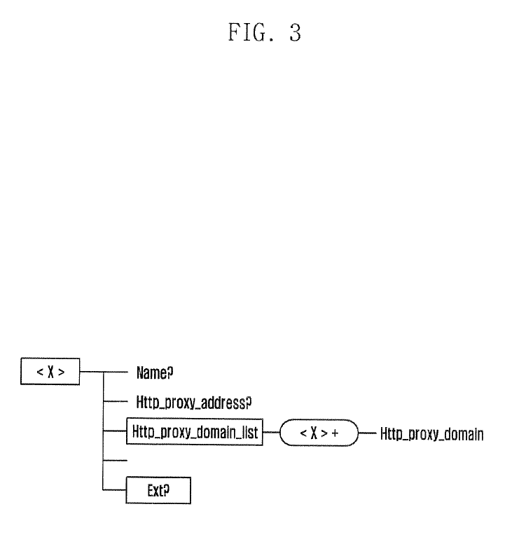

Now, a method for obtaining the HTTP proxy related information at the terminal (i.e., UE) will be described with reference to FIGS. 2 and 3.

FIG. 2 shows a signal flow among respective entities to obtain HTTP proxy related information in accordance with an embodiment of the present invention. FIG. 3 shows an HTTP proxy management object stored in a terminal in accordance with an embodiment of the present invention.

First, a method for obtaining the HTTP proxy related information through information received from a network in a procedure of accessing the network by UE will be described with reference to FIG. 2. FIG. 2 shows a scheme in which the UE makes an attach request including a request for HTTP proxy related information at an initial access to the network and then the network compares the received request with user's subscription information and offers the HTTP proxy related information to the UE.

When initially accessing the network, the UE may obtain the HTTP proxy related information through information transferred from the network. Namely, the HTTP proxy related information may be obtained during an attach procedure. Specifically, the UE may transmit an initial access request, including a request for the HTTP proxy related information, to the network. Then the UE may obtain the HTTP proxy related information from the network. Alternatively, the network may transfer the HTTP proxy related information to the UE without a request of the UE.

More specifically, at step S201, a UE 210 may transmit an Attach Request to the network. The Attach Request may include an HTTP proxy information requested indicator. The UE 210 may transmit the Attach Request to a base station (hereinafter, referred to as an eNB) 220. The HTTP proxy information requested indicator is a specific indicator proposed in this embodiment of the invention. This indicator means that the UE 210 requests a quick HTTP connection proposed in this embodiment. The HTTP proxy information requested indicator may be contained in PCO which is a parameter used to communicate with a P-gateway (PGW) 250, or alternatively transmitted as an independent parameter.

At step S203, the eNB 220 may transfer, to an MME 230, the Attach Request (including the HTTP proxy information requested indicator) received at step S201.

At steps S205 and S207, the MME 230 may receive user's subscription information from an HSS 260 through Update Location Request/Ack messages.

At step S209, the MME 230 checks the user's subscription information and thereby determines whether to be able to offer an HTTP proxy service to a user.

Now, a procedure in case of offering the HTTP proxy service will be described through step S210, and a normal service procedure in case of offering no HTTP proxy service will be described through step S230.

In case of offering the HTTP proxy service to a user according to subscription information, the MME 230 may transmit a Create Default Bearer Request to the PGW 250 through an S-gateway (SGW) 240 at steps S211 and S212. The Create Default Bearer Request may contain the HTTP proxy information requested indicator. At this time, the HTTP proxy information requested indicator may be an indicator received from the Attach Request message. If the HTTP proxy information requested indicator is contained in PCO, the MME 230 should check a PCO value.

At step S213, the PGW 250 receiving the HTTP proxy information requested indicator may check HTTP proxy related information. The HTTP proxy related information may contain an HTTP proxy address and/or information about HTTP proxy connected domain.

At steps S215 and S216, the PGW 250 may transfer the HTTP proxy related information to the MME 230 through the SGW 240.

At step S217, the MME 230 may transmit an Initial Context Setup Request/Attach Accept message to the eNB 220. The Initial Context Setup Request/Attach Accept message may contain the HTTP proxy related information.

At step S219, the eNB 220 may transfer the HTTP proxy related information to the UE 210 through an RRC connection reconfiguration procedure. Then the UE 210 may store therein the received HTTP proxy related information. Thereafter, through steps S251 to S257, an Attach procedure may be performed.

If it is determined at step S209 to fail to offer an HTTP proxy service, the network may operate at S230.

In case of offering no HTTP proxy service to a user according to subscription information, the MME 230 may transmit an existing Create Default Bearer Request message to the SGW 240 at step S231. Then, at step S233, the SGW 240 may transfer the existing Create Default Bearer Request to the PGW 250. At steps S235 and S237, a Create Default Bearer Response may be transferred from the PGW 250 to the MME 230 through the SGW 240. At step S239, the MME 230 may transmit an Initial Context Setup Request/Attach Accept message to the eNB 220. At step S241, the eNB 220 may perform an RRC connection reconfiguration procedure. Namely, step S230 may be performed using an existing bearer setup process.

Thereafter, the UE 210 performs an Attach procedure.

In case the HTTP proxy related information is changed, the network may transfer changed information to the UE. In case of LTE network, any changed HTTP proxy related information may be transferred from the PGW 250 to the UE 210 through a bearer update procedure. Alternatively, the HTTP proxy related information may be updated when the UE 210 sends periodically the Attach Request.

Even after access to the network is ended, the UE 210 may store the HTTP proxy related information, especially the entire or part of the HTTP proxy related information.

Now, another embodiment for obtaining HTTP proxy related information by UE will be described with reference to FIG. 3.

Another method for obtaining the HTTP proxy related information by the UE is that a mobile communication operator transfers the HTTP proxy related information to the UE by means of OMA-DM technique. The UE may store an HTTP proxy address and/or HTTP proxy domain information in the form of management object (MO). In this disclosure, the MO is referred to as HTTP proxy MO.

FIG. 3 shows an HTTP proxy management object stored in a terminal in accordance with an embodiment of the present invention.

In FIG. 3, “Http_proxy_address” indicates an address of HTTP proxy. Table 1 shows an embodiment of the HTTP proxy address.

TABLE 1
/<X>/Http proxy address

The Http proxy address leaf defines an FQDN or an IPv4 address to
an IPv4 Http proxy server.
Occurrence: ZeroOrOne
Format: chr
Access Types: Get, Replace
Values: <A fully qualified domain name> or <IPv4 address>

<Http_proxy_domain_List>node and <Http_proxy_domain>leaf represent http proxy domains. Tables 2 and 3 show an available format.

TABLE 2
/<X>/Http_proxy_domain_List/<X>

This run-time node acts as a placeholder for one or more Http proxy
domains.
Occurrence: OneOrMore
Format: node
Access Types: Get
Values: N/A

TABLE 3
/<X>/Http_proxy_domain_List/<X>/Http_proxy_domain

The Http_proxy_domain leaf represents one or more Http proxy domains.
Occurrence: One
Format: chr
Access Types: Get
Values: <A http proxy domain>

Now, a method for establishing an HTTP proxy connection will be described. The HTTP proxy connection may be established at a certain time point after the UE performs the Attach procedure, or when the UE tries an access to an HTTP proxy domain.

In case the UE establishes the HTTP proxy connection at a certain time point after the Attach procedure, the UE may automatically create the HTTP proxy connection using HTTP proxy related information without user's request for access to HTTP proxy domain. Alternatively, the UE may create the HTTP proxy connection in case a user requests access to one of HTTP proxy domains.

Thereafter, when the UE accesses a specific domain in the HTTP proxy domain list, the HTTP request is transmitted to the HTTP proxy through a pre-established HTTP proxy connection without establishing any HTTP connection.

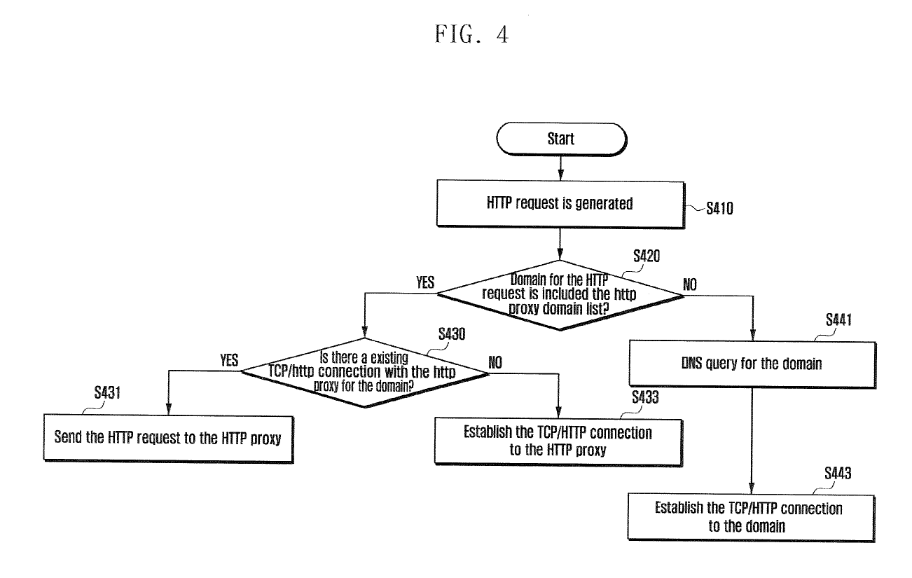

FIG. 4 is a flow diagram illustrating the operation of a terminal in response to an HTTP request in accordance with an embodiment of the present invention. FIG. 4 shows the operation of the terminal according to on-demand type.

Referring to FIG. 4, at step S410, an HTTP request is generated at UE. At step S420, the UE may determine whether a domain for the HTTP request is included in an HTTP proxy domain list.

If it is determined that the domain for the HTTP request is included in the HTTP proxy domain list, step S430 is performed. At step S430, the UE may check whether there is an HTTP proxy connection. If there is the HTTP proxy connection, the UE may transfer the HTTP request to an HTTP proxy through the HTTP proxy connection at step S431. If there is no HTTP proxy connection, the UE may establish a new HTTP proxy connection.

Meanwhile, if it is determined at step S420 that the domain for the HTTP request is not included in the HTTP proxy domain list, the UE may perform an existing HTTP connection setup procedure.

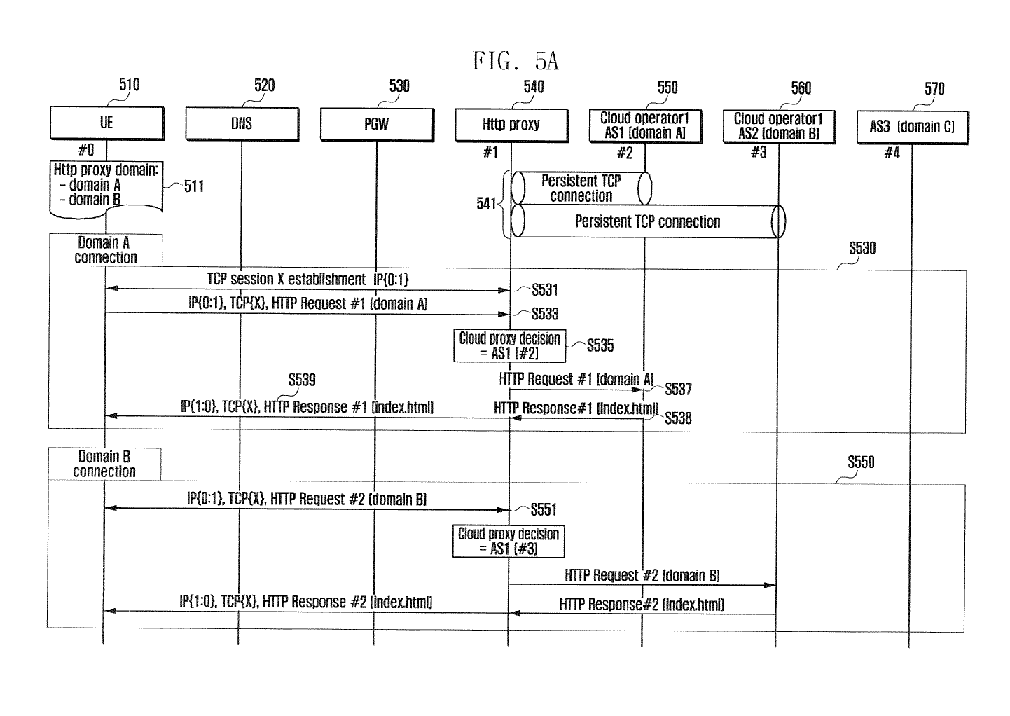

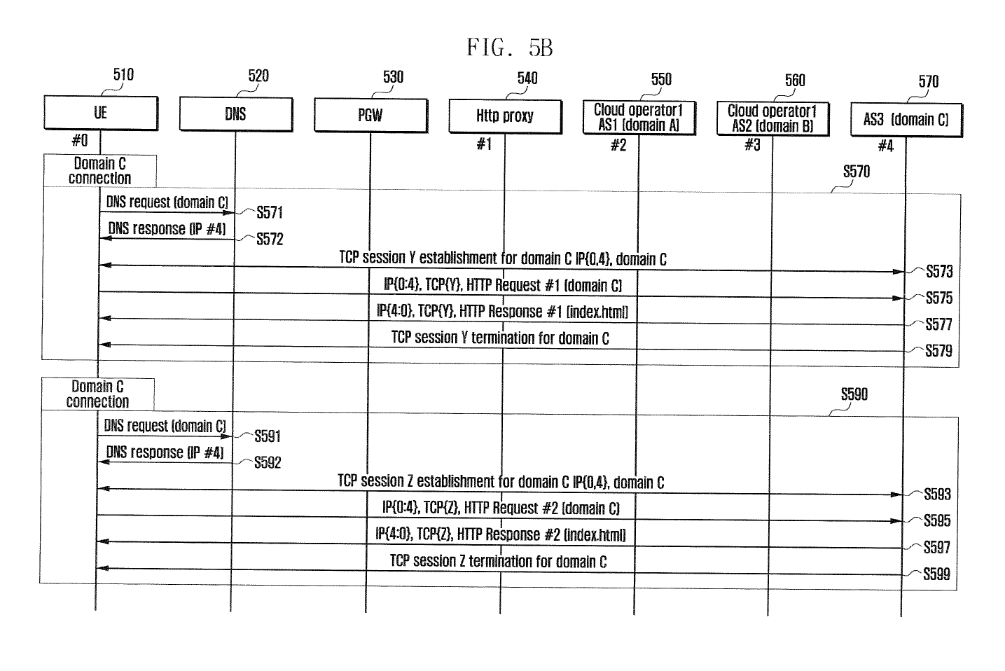

FIGS. 5A and 5B show HTTP proxy domain access procedures of a terminal in accordance with embodiments of the present invention. Namely, FIGS. 5A and 5B show a procedure in which the terminal trying an access to an HTTP proxy domain establishes an HTTP proxy connection and then accesses an HTTP proxy without establishing the HTTP proxy connection. In case the HTTP proxy connection has been already established, and in case UE accesses a domain included in an HTTP proxy domain list, it is possible to send an HTTP request to the HTTP proxy through a pre-established HTTP proxy connection without establishing a new HTTP connection.

The UE 510 stores therein domain A and domain B as HTTP proxy domains at step 511. A mobile communication network operator has made a contract for HTTP proxy service with a cloud operator 1. Therefore, at step S541, the HTTP proxy 540 has had pre-established guaranteed HTTP connection with AS1 550 and AS2 560 which respectively offer services of domains A and B. The guaranteed HTTP connection may be a persistent TCP connection.

Step S530 shows an operation in case the UE performs an attach procedure and then initially tries to access a domain A.

The UE 510 checks that the domain A is included in the HTTP proxy domain list, and also checks that no HTTP proxy connection is established. At step S531, the UE 510 establishes the HTTP proxy connection with the HTTP proxy 540. At step S533, the UE 510 transmits the HTTP request for the domain A to the HTTP proxy 540. At step S535, the HTTP proxy 540 may select a cloud operator which offers a service of domain A. If there are two or more cloud operators offering a service of domain A, the HTTP proxy 540 may select the most efficient cloud operator. At step S537, the HTTP proxy 540 transfers the HTTP request, received from the UE, to the AS1 550. Additionally, the HTTP proxy 540 receives an HTTP response from the AS1 550 at step S538 and transfers the received HTTP response to the UE 510 at step S539.

Thereafter, the UE 510 tries to access a domain B according to step S550. The UE 510 checks that the domain B is included in the HTTP proxy domain list and the HTTP proxy connection is established. At step S551, the UE 510 transmits the HTTP request for the domain B to the HTTP proxy 540. At step S553, the HTTP proxy 540 may select a cloud operator which offers a service of domain B. Then the HTTP proxy 540 transfers the HTTP request, received from the UE 510, to the AS2 560. Also, the HTTP proxy 540 receives an HTTP response from the AS2 560 and transfers the received HTTP response to the UE 510.

Next, an operation in case a domain requested by the UE is not included in the HTTP proxy domain list will be described with reference to steps S570 and S590.

The UE 510 desires to access a domain C. The UE 510 checks that the domain C is not included in the HTTP proxy domain list. Then the UE 510 performs a DNS query procedure at steps S571 and S572 and performs at step S573 an HTTP connection with an AS3 570 which offers a service of the domain C. Also, the UE 510 transmits and receives a request and response to and from the AS3 570 through the HTTP connection at steps S575 and S577. When the service between the UE 510 and the AS3 570 is ended, the UE 510 or the AS3 570 terminates the HTTP connection at step S579.

Thereafter, in case the UE 510 desires to access again the domain C according to step S590, the UE 510 should perform all processes performed at step S570. Namely, the UE 510 checks that the domain C is not included in the HTTP proxy domain list. Then the UE 510 performs a DNS query procedure at steps S591 and S592 and performs at step S593 an HTTP connection with an AS3 570 which offers a service of the domain C. Also, the UE 510 transmits and receives a request and response to and from the AS3 570 through the HTTP connection at steps S595 and S597. When the service between the UE 510 and the AS3 570 is ended, the UE 510 or the AS3 570 terminates the HTTP connection at step S599.

As discussed above, in case of a domain that supports an HTTP proxy service in an embodiment of this invention, an HTTP request can be processed without requiring separate DNS query and HTTP connection. This may enhance user's QoE.

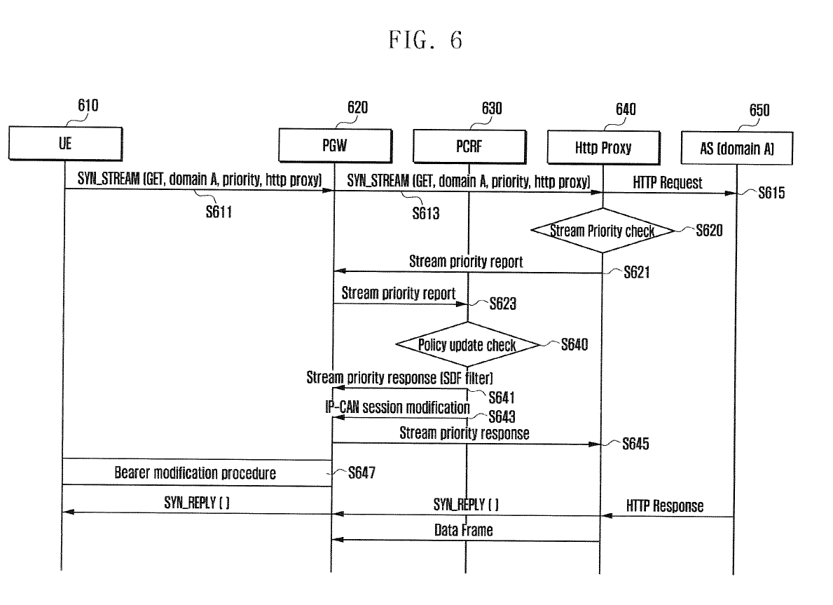

Now, a method for applying the priority of the HTTP request to QoS of an operator network will be described with reference to FIG. 6. FIG. 6 shows a network operation in case an HTTP request contains a priority indicator. An explanation for FIG. 6 will be made using exemplarily SPDY protocol.

Referring to FIG. 6, proposed is the HTTP proxy for allocating proper QoS to the UE according to the priority of the HTTP request. In an embodiment of this invention, the HTTP proxy is located on the operator network and transfers information about the priority of the HTTP request to an entity which takes charge of QoS of the operator network such that the UE can obtain proper QoS.

At steps S611 and S613, the UE 610 may transmit SYN_STREAM (priority, HTTP proxy, etc.) to the HTTP proxy 640 through the PGW 620. SYN_STREAM may include a priority indicator for the HTTP request as well as information about the HTTP proxy. At step S615, the HTTP proxy 640 may transfer the HTTP request to the web server 650.

The HTTP proxy 640 may check the priority from the received stream at step S620. In case of the HTTP request having a specific priority indicator, the HTTP proxy 640 may report it to the PGW 620 at step S621. This specific priority indicator may be determined by means of operator's configuration.

At step S623, the PGW 620 may transfer the stream priority report to the PCRF 630. At step S640, the PCRF 630 may determine whether a bearer modification is needed on the basis of the received priority indicator. At step S641, the PCRF 630 may transfer an SDF filter to the PGW 620. At step S643, the PCRF 630 performs a bearer modification procedure. At step S645, the PGW 620 may transfer a response message regarding the stream priority report to the HTTP proxy 640.

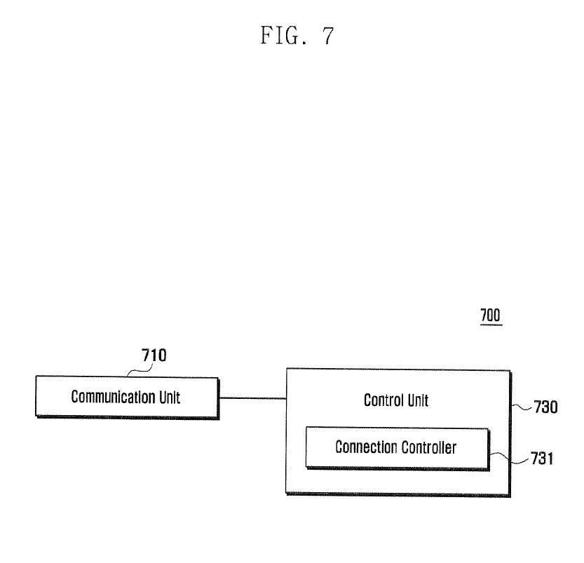

FIG. 7 is a block diagram illustrating a terminal in accordance with an embodiment of the present invention.

Referring to FIG. 7, the terminal 700 may include a communication unit 710 for performing wired/wireless communications and a control unit 730 for controlling the overall operation thereof. The control unit 730 may have a connection controller 731, which may support the operation of an HTTP proxy service in embodiments of this invention.

The connection controller 731 may receive an HTTP request for at least one domain and determine whether the domain supports the HTTP proxy service. If the domain supports the HTTP proxy service, the connection controller 731 may control the transmission of the HTTP request to the HTTP proxy through a pre-established HTTP proxy connection.

Additionally, the connection controller 731 may determine whether the domain is included in the HTTP proxy domain list, and also may control the reception of the HTTP proxy related information from the PGW at an initial network access.

Additionally, the connection controller 731 may control the reception of the HTTP proxy related information from a device management (DM) server. At this time, the HTTP proxy related information contains an HTTP proxy address forming an OMA-DM tree and information about an HTTP proxy domain list.

Additionally, the connection controller 731 may control the HTTP connection with the HTTP proxy which has a persistent HTTP connection with a server which services the domain.

Although it is described above that the terminal 700 is formed of blocks, this is exemplary only and not to be considered as a limitation. Alternatively, any function or operation of the connection controller 731 may be performed by the control unit 730. Further, it will be obvious that any other function or operation, even though not discussed above, of the connection controller 731 may be performed for the HTTP proxy service discussed earlier in embodiments shown in FIGS. 1 to 6.

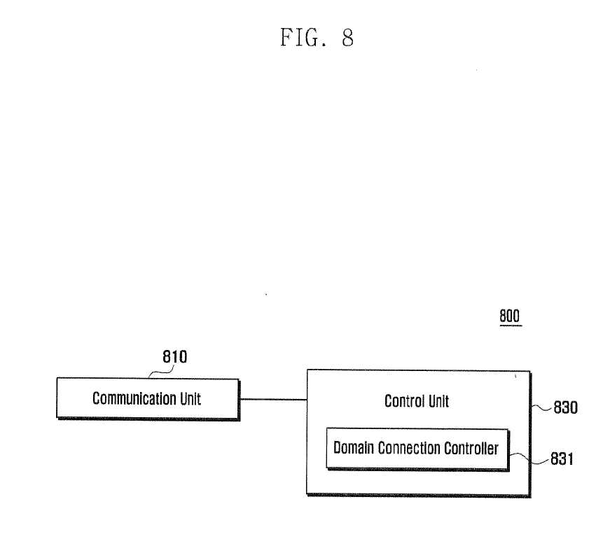

FIG. 8 is a block diagram illustrating an HTTP proxy in accordance with an embodiment of the present invention.

Referring to FIG. 8, the HTTP proxy 800 may include a communication unit 810 for performing wired/wireless communications and a control unit 830 for controlling the overall operation thereof. The control unit 830 may have a domain connection controller 831, which may support the operation of an HTTP proxy service in embodiments of this invention.

The domain connection controller 831 may establish a persistent HTTP connection with a server which services at least one HTTP domain. Also, the domain connection controller 831 may receive an HTTP request for at least one domain from a terminal through the HTTP proxy connection established between the terminal and the HTTP proxy. And also, the domain connection controller 831 may control the transmission of the received HTTP request to the server through the HTTP connection.

Although it is described above that the HTTP proxy 800 is formed of blocks, this is exemplary only and not to be considered as a limitation. Alternatively, any function or operation of the domain connection controller 831 may be performed by the control unit 830. Further, it will be obvious that any other function or operation, even though not discussed above, of the domain connection controller 831 may be performed for the HTTP proxy service discussed earlier in embodiments shown in FIGS. 1 to 6.

According to embodiments of this invention, it is possible to offer more quickly an HTTP service, occupying most of mobile communication network traffic, to users. The terminal can quickly access a frequently used domain, and the operator can provide a differentiated service.

While this invention has been particularly shown and described with reference to an exemplary embodiment thereof, it will be understood by those skilled in the art that various changes in form and details may be made therein without departing from the spirit and scope of this invention as defined by the appended claims.

What is claimed is:

1. A method for connecting with a web server at a terminal, the method comprising:
receiving an HTTP (HyperText Transfer Protocol) request for at least one domain;
determining whether the domain supports an HTTP proxy service; and
if the domain supports the HTTP proxy service, transmitting the HTTP request to an HTTP proxy through a pre-established HTTP proxy connection.

2. The method of claim 1, wherein the HTTP proxy connection is directly established between the terminal and the HTTP proxy corresponding to HTTP proxy related information.

3. The method of claim 2, wherein the HTTP proxy related information includes an address of each HTTP proxy and information about an HTTP proxy domain list.

4. The method of claim 3, wherein the determining includes determining whether the domain is included in the HTTP proxy domain list.

5. The method of claim 2, further comprising:
obtaining the HTTP proxy related information from a P-gateway at an initial network access.

6. The method of claim 2, further comprising:
obtaining the HTTP proxy related information from a device management (DM) server wherein the HTTP proxy related information contains an HTTP proxy address forming OMA-DM tree and information about an HTTP proxy domain list.

7. The method of claim 1, wherein the HTTP proxy has a persistent HTTP connection with a server which services the domain.

8. A terminal comprising:
a communication unit configured to perform a data communication; and
a connection controller configured to receive an HTTP (HyperText Transfer Protocol) request for at least one domain, to determine whether the domain supports an HTTP proxy service, and if the domain supports the HTTP proxy service, to transmit the HTTP request to an HTTP proxy through a pre-established HTTP proxy connection.

9. The terminal of claim 8, wherein the HTTP proxy connection is directly established between the terminal and the HTTP proxy corresponding to HTTP proxy related information.

10. The terminal of claim 9, wherein the HTTP proxy related information includes an address of each HTTP proxy and information about an HTTP proxy domain list.

11. The terminal of claim 10, wherein the connection controller is further configured to determine whether the domain is included in the HTTP proxy domain list.

12. The terminal of claim 9, wherein the connection controller is further configured to obtain the HTTP proxy related information from a P-gateway at an initial network access.

13. The terminal of claim 9, wherein the connection controller is further configured to obtain the HTTP proxy related information from a device management (DM) server wherein the HTTP proxy related information contains an HTTP proxy address forming OMA-DM tree and information about an HTTP proxy domain list.

14. The terminal of claim 9, wherein the connection controller is further configured to establish an HTTP connection with the HTTP proxy having a persistent HTTP connection with a server which services the domain.

15. A method for connecting with a web server at an HTTP (HyperText Transfer Protocol) proxy, the method comprising:
establishing a persistent HTTP connection with a cloud operator which services at least one domain;
receiving an HTTP request for the domain from a terminal through an HTTP proxy connection established between the terminal and the HTTP proxy; and
transmitting the received HTTP request to the cloud operator through the HTTP connection.

16. An HTTP (HyperText Transfer Protocol) proxy comprising:
a communication unit configured to perform a data communication; and
a domain connection controller configured to establish a persistent HTTP connection with a server which services at least one domain, to receive an HTTP request for the at least one domain from a terminal through an HTTP proxy connection established between the terminal and the HTTP proxy, and to transmit the received HTTP request to the server through the HTTP connection.
